(19) United States
(12) Patent Application Publication
(10) Pub. No.: US 2021/0235637 A1
(43) Pub. Date: Aug. 5, 2021

(54) PLANT-CULTIVATING AND PROTECTING APPARATUS

(71) Applicant: Chao Quan Zhen, Rosemead, CA (US)

(72) Inventor: Chao Quan Zhen, Rosemead, CA (US)

(21) Appl. No.: 16/780,013

(22) Filed: Feb. 3, 2020

(51) Int. Cl. A01G 13/02; A01G 9/02

(52) U.S. Cl. CPC A01G 13/0237; A01G 2009/003; A01G 9/02

(57) ABSTRACT

A plant-cultivating and protecting apparatus wraps overlapped smaller and larger plant-cultivating media. The plant-cultivating and protecting apparatus includes a cover and a frame. The cover extends around an upper portion of the plant-cultivating medium. The frame extends around a lower portion of the smaller plant-cultivating medium. The frame is formed on the cover in one piece, thereby avoiding detachment of the frame from the cover.

### BACKGROUND OF INVENTION

### 1. Field of Invention

The present invention relates to cultivation of plants and, more particularly, to a plant-protecting apparatus used in the cultivation of plants.

2. Related Prior Art

Rock wool culture is a common practice to cultivate a plant in a rock-wool block. Referring to FIGS. 8 and 9, two rock-wool blocks 2 and 3 are overlapped and used as a medium for cultivation of a plant. The periphery of the rock-wool blocks 2 is wrapped by a plastic foil 21. The periphery of the rock-wool blocks 3 is wrapped by a plastic foil 31. Thus, water and/or culture solution cannot leak from the rock-wool blocks 2 and 3 through the peripheries of the rock-wool blocks 2 and 3. In addition, the peripheries of the rock-wool blocks 2 and 3 are kept from sun light so that moss, mold and/or weeds cannot grow on the peripheries of the rock-wool blocks 2 and 3.

Referring to FIG. 10, roots 41 of a plant 4 reach the rock-wool block 3 from the rock-wool block 2. Referring to FIG. 11, the rock-wool block 2 might be biased or even detached from the rock-wool block 3 if they are bumped. In such cases, the roots 41 would be broken, thereby gravely affecting the growth of the plant 4 or even resulting in death of the plant 4.

Moreover, referring to FIGS. 9 and 10, an entire upper face of the rock-wool block 2 is exposed, and a peripheral portion 30 of an upper face of the rock-wool block 3 is exposed for not being covered by the rock-wool block 2. The exposure affects the growth of the plant 4. There is an irrigation apparatus that covers the upper face of the rock-wool block 2 like a cover. Thus, the upper face of the rock-wool block 2 is kept from the sun light to prevent moss, mold and/or weeds from growing on the upper face of the rock-wool block 2. However, the irrigation apparatus fails to cover the peripheral portion 30 of the upper face of the rock-wool block 3 so that moss, mold and/or weeds inevitably grow on the peripheral portion 30 of the upper face of the rock-wool block 3.

The present invention is therefore intended to obviate or at least alleviate the problems encountered in prior art.

### SUMMARY OF INVENTION

It is the primary objective of the present invention to provide a plant-cultivating and protecting apparatus for wrapping overlapped smaller and larger plant-cultivating media.

To achieve the foregoing objective, the plant-cultivating and protecting apparatus includes a cover and a frame. The cover extends around an upper portion of the plant-cultivating medium. The frame extends around a lower portion of the smaller plant-cultivating medium. The frame is formed on the cover in one piece, thereby avoiding detachment of the frame from the cover.

Other objectives, advantages and features of the present invention will be apparent from the following description referring to the attached drawings.

### BRIEF DESCRIPTION OF DRAWINGS

The present invention will be described via detailed illustration of the preferred embodiment versus the prior art referring to the drawings wherein:

FIG. 1 is a perspective view of two rock-wool blocks and a plant-cultivating and protecting apparatus according to the preferred embodiment of the present invention;

FIG. 2 is a perspective view of the rock-wool blocks wrapped by the plant-cultivating and protecting apparatus shown in FIG. 1;

FIG. 3 is another perspective view of the plant-cultivating and protecting apparatus shown in FIG. 1;

FIG. 4 is a cross-sectional view of a plant cultivated at the rock-wool blocks wrapped by the plant-cultivating and protecting apparatus shown in FIG. 2;

FIG. 5 is an enlarged, partial, perspective view of the plant-cultivating and protecting apparatus shown in FIG. 2;

FIG. 6 is an enlarged, partial, cross-sectional view of the rock-wool blocks wrapped by the plant-cultivating and protecting apparatus shown in FIG. 2;

FIG. 7 is a front view of a pile of plant-protecting apparatuses as shown in FIG. 1;

FIG. 8 is a perspective view of two rock-wool blocks used in the conventional rock-wool culture;

FIG. 9 is a perspective view of the rock-wool blocks shown in FIG. 8 overlapped;

FIG. 10 is a cross-sectional view of a plant cultivated at the rock-wool blocks shown in FIG. 9; and

FIG. 11 is a cross-sectional view of the rock-wool blocks of FIG. 9 detached from each other.

### DETAILED DESCRIPTION OF PREFERRED EMBODIMENT

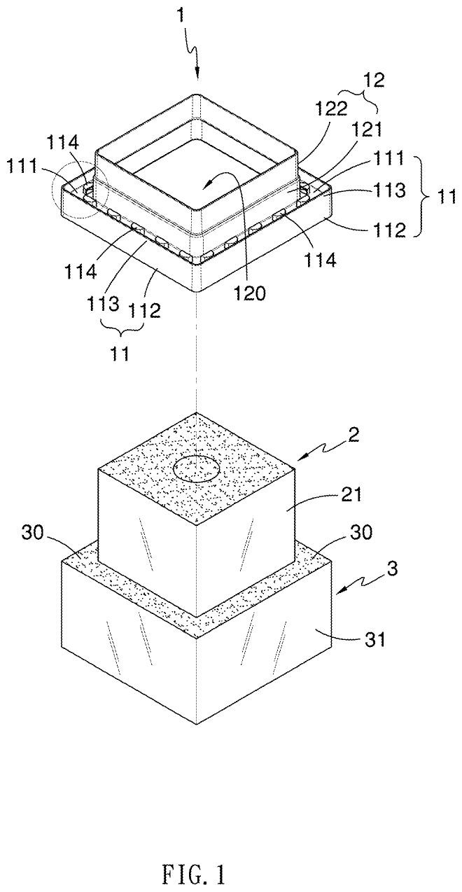

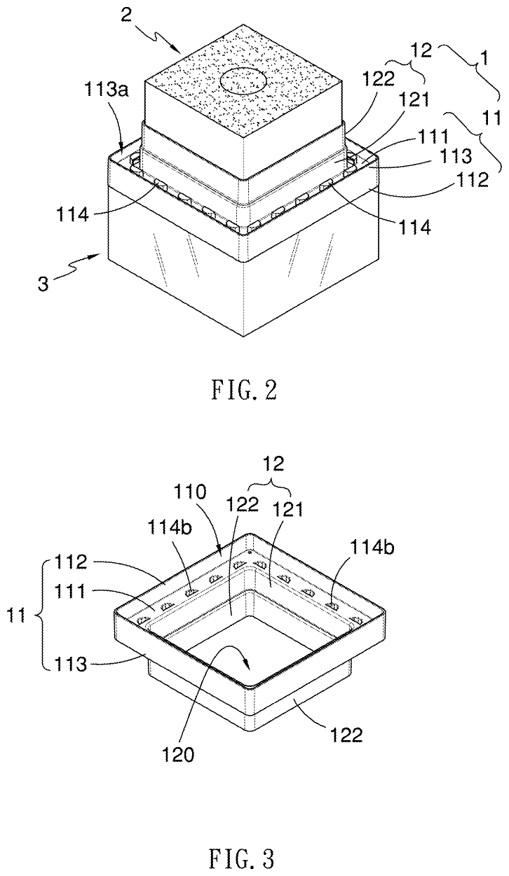

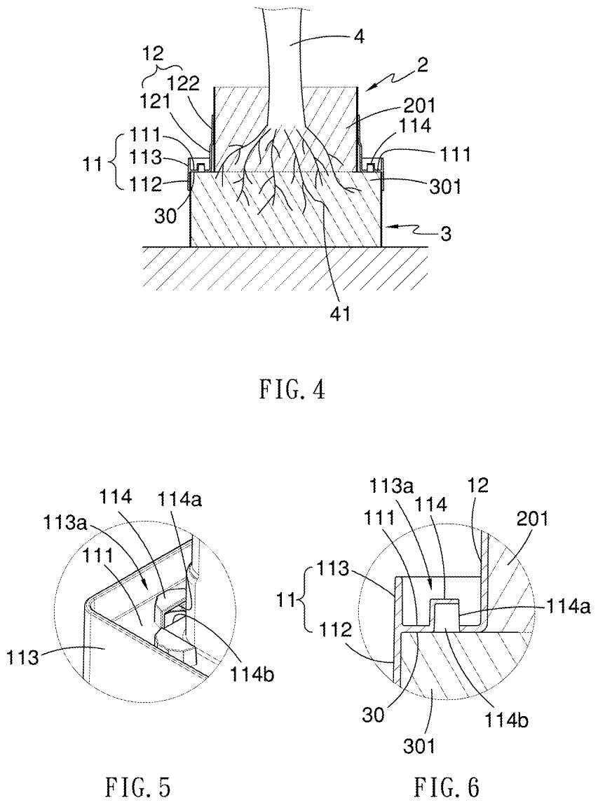

Referring to FIGS. 1 and 2, in rock-wool culture, a plant 4 (FIG. 4) is cultivated at two rock-wool blocks 2 and 3 that are wrapped with a plant-cultivating and protecting apparatus 1 according to the preferred embodiment. The rock-wool block 2 is smaller than the rock-wool block 3. The rock-wool block 2 is supported on the rock-wool block 3. The rock-wool block 2 covers a central portion of the upper face of the rock-wool block 3. The periphery of the rock-wool block 2 is wrapped with a plastic foil 21. The periphery of the rock-wool block 3 is wrapped with a plastic foil 31.

Referring to FIG. 1, the plant-cultivating and protecting apparatus 1 includes a cover 11 formed beneath a frame 12. The cover 11 and the frame 12 are made in one piece so that they cannot be detached from each other arbitrarily unless the plant-cultivating and protecting apparatus 1 is damaged.

Referring to FIGS. 1 and 3, the cover 11 is formed with a chamber 110. The frame 12 includes a channel 120. The chamber 110 is in communication with the channel 120.

Referring to FIGS. 2 and 4, the plant-cultivating and protecting apparatus 1 is provided on the rock-wool blocks 2 and 3 so that the cover 11 wraps the rock-wool block 3 and the frame 12 wraps the rock-wool block 2. In the preferred embodiment, the cover 11 wraps an upper portion 301 of the rock-wool block 3 and the frame 12 wraps a lower portion 201 of the rock-wool block 2. The upper portion 301 of the rock-wool block 3 includes an upper face that includes a peripheral portion 30 not covered with the rock-wool block 2.

The rock-wool blocks 2 and 3 cannot be biased or detached from each other when they are bumped because the frame 12 cannot be detached from the cover 11 and because the cover 11 wraps the rock-wool block 3 and the frame 12 wraps the rock-wool blocks 2 when the plant-cultivating and protecting apparatus 1 is provided on the rock-wool blocks 2 and 3. Thus, roots 41 of the plant 4 cannot be broken which could occur should the rock-wool blocks 2 and 3 are biased or detached from each other.

Preferably, referring to FIGS. 1 and 3, the frame 12 is made in one piece with the cover 11. The frame 12 includes a lower rim 121 extending from the cover 11 and an upper rim 122 extending from the lower rim 121. An internal size of the channel 120 of the frame 12 is larger in a lower rim 121 than in the upper rim 122.

Referring to FIG. 4, the plant-cultivating and protecting apparatus 1 is provided on the overlapped rock-wool blocks 2 and 3 so that an internal face of the upper rim 122 is in contact with the periphery of the rock-wool block 2 and there is a gap between an internal face of the lower rim 121 and the periphery of the rock-wool block 2.

Preferably, referring to FIGS. 1 and 3, the cover 11 includes a covering plate 111, a lower edge 112 extending downward from an external edge of the covering plate 111, and an upper edge 113 extending upward from the external edge of the covering plate 111. The lower rim 122 of the frame 12 extends upward from an internal edge of the covering plate 111. The chamber 110 is made in the lower edge 112 of the cover 11.

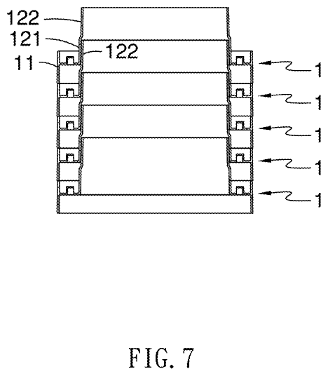

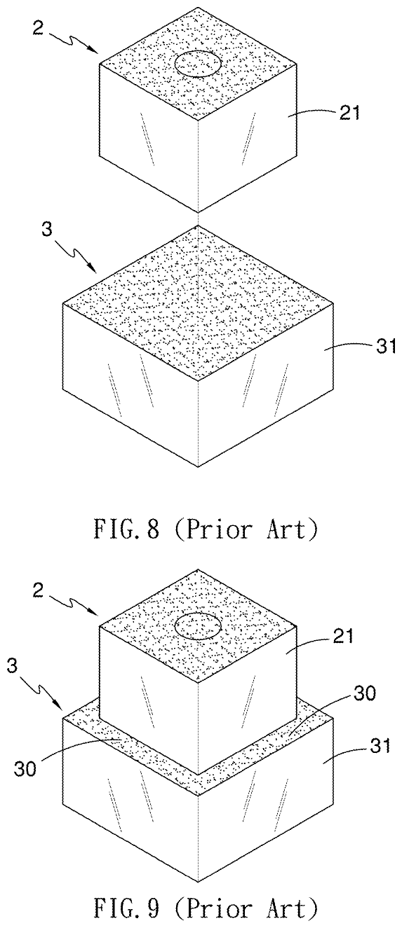

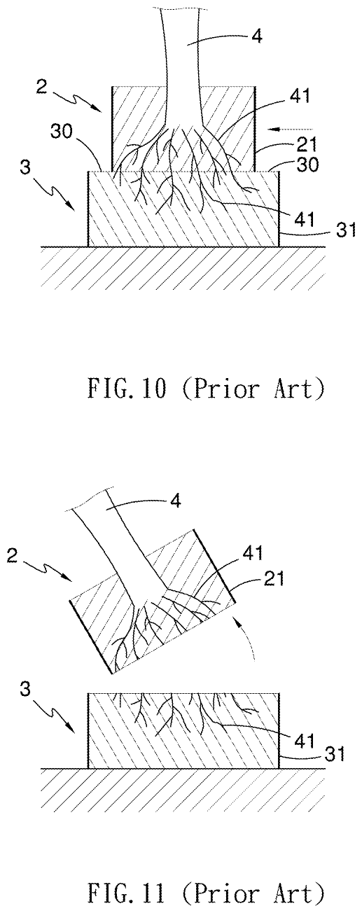

Referring to FIG. 7, several plant-cultivating and protecting apparatuses 1 can be overlapped due to the lower edge 112 and the lower and upper rims 121 and 122 of different sizes. Thus, the plant-cultivating and protecting apparatuses 1 occupy a compact space during storage or transportation.

The peripheral portion 30 of the upper face of the rock-wool block 3, which is not covered with the rock-wool blocks 2, is covered with the covering plate 111 of the cover 11. Thus, the peripheral portion 30 of the upper face of the rock-wool block 3 is kept from sun light so that moss, mold and/or weeds cannot grow on the peripheral portion 30 of the upper face of the rock-wool block 3

The covering plate 111 includes conduits 114. Referring to FIGS. 2, 5 and 6, the upper edge 113, the covering plate 111 and the lower rim 121 together provide a trough 113a for containing water and/or culture solution. Each of the conduits 114 renders the trough 113a in communication with the chamber 110 so that the water and/or culture solution can travel to the rock-wool block 3 from the trough 113a through the conduits 114.

Preferably, referring to FIGS. 5 and 6, each of the conduits 114 includes a vertical orifice 114a and a horizontal orifice 114b. The vertical orifice 114a extends perpendicular to the covering plate 111 and faces the frame 12. The horizontal orifice 114b is made in the covering plate 111. Thus, the sun light cannot reach the peripheral portion 30 of the upper face of the rock-wool block 3 through the conduits 114.

In the preferred embodiment, the plant-cultivating and protecting apparatus 1 is made of opaque plastics. However, in another embodiment, the plant-cultivating and protecting apparatus 1 can be made of transparent plastics if the problem with moss, mold and/or weeds is not considered.

The present invention has been described via the illustration of the preferred embodiment. Those skilled in the art can derive variations from the preferred embodiment without departing from the scope of the present invention. Therefore, the preferred embodiment shall not limit the scope of the present invention defined in the claims.

1. A plant-cultivating and protecting apparatus for wrapping overlapped smaller and larger plant-cultivating media, the plant-cultivating and protecting apparatus comprising:
a cover extending around an upper portion of the plant-cultivating medium; and
a frame extending around a lower portion of the smaller plant-cultivating medium,
wherein the frame is formed on the cover in one piece, thereby avoiding detachment of the frame from the cover.

2. The plant-cultivating and protecting apparatus according to claim 1, wherein the cover comprises a chamber for containing the upper portion of the plant-cultivating medium, the frame comprises a channel for containing the lower portion of the plant-cultivating medium, and the channel of the frame is in communication with the chamber of the cover.

3. The plant-cultivating and protecting apparatus according to claim 2, wherein the frame comprises a lower rim extending from the cover and an upper rim extending from the lower rim, and an internal size of the channel of the frame is larger in the lower rim than in the upper rim.

4. The plant-cultivating and protecting apparatus according to claim 2, wherein the cover comprise a covering plate and a lower edge extending downward from the covering plate, and the chamber is made in the lower edge.

5. The plant-cultivating and protecting apparatus according to claim 4, wherein the upper edge, the covering plate and the frame together provide a trough.

6. The plant-cultivating and protecting apparatus according to claim 5, wherein the cover comprises an upper edge extending upward from the covering plate and conduits made in the covering plate, and each of the conduits renders the trough in communication with the chamber.

7. The plant-cultivating and protecting apparatus according to claim 6, wherein each of the conduits comprises:
a vertical orifice extending perpendicular to the covering plate and facing the frame; and a horizontal orifice made in the covering plate.
